(19) United States
(12) Patent Application Publication
(10) Pub. No.: US 2009/0196764 A1
(43) Pub. Date: Aug. 6, 2009

(54) HIGH FREQUENCY ELECTRIC-DRIVE WITH MULTI-POLE MOTOR FOR GAS PIPELINE AND STORAGE COMPRESSION APPLICATIONS

(76) Inventors: James M. Fogarty, Schenectady, NY (US); Christopher A. Kaminski, Schenectady, NY (US); Konrad R. Weeber, Rexford, NY (US); Yu Wang, Mason, OH (US); Rajib Datta, Niskayuna, NY (US)

Correspondence Address: NIXON & VANDERHYE P.C., 901 NORTH GLEBE ROAD, 11TH FLOOR, ARLINGTON, VA, 22203, US

(21) Appl. No.: 12/025,227

(22) Filed: Feb. 4, 2008

(51) Int. Cl. F04B 49/06; H02P 27/04; H02H 7/10

(52) U.S. Cl. 417/44.1; 318/503; 363/50

(57) ABSTRACT

An integrated electric-drive compressor system utilizes a high frequency drive for powering the multi-pole pair motor. The electric motor and compressor are housed in a common pressure casing. The electric motor has added permanent magnets for achieving higher ratings and higher speeds.

### BACKGROUND OF THE INVENTION

Oil and gas pipeline compressors are conventionally driven by gas turbines, low-speed synchronous motors with a gearbox, and high-speed directly coupled induction or synchronous motors. Some of the above types of drives for the turbine are more advantageous compared to others.

In general, electric drives utilizing a motor to power the compressor have advantages relative to mechanical drives which utilize a gas turbine for the same purpose. Electric drives offer operational flexibility, since they may have variable speed, as well as maintainability and reliability.

Among electric drive systems, high speed drives are characterized by smaller foot print, simplicity (e.g., eliminating gear box), easier integrated cooling with the compressor, and potential higher reliability, compared to low speed electric drives with gear box.

Prior art machines, such as wound-rotor synchronous machines, cover a space of higher ratings at lower speeds than induction motors. However, the maximum induction motor speed is limited to around 14,000 rpm because of rotor dynamics challenges.

At present, electric-drive compressor systems employed in the oil and gas industry do not utilize high frequency drive motors. There has been a recognized need for large high speed electric drive motors for operation in a pressurized gas, such as methane, environment.

### BRIEF DESCRIPTION OF THE INVENTION

Described herein, is an integrated electric drive compressor system, which may be used in upstream, midstream, and downstream compressor applications in the oil and gas industry. The integrated system may operate in harsh environments, such as raw gas or acid gas, and ultimately in subsea applications on or beyond the continental shelf, where water pressures are extremely high, and access is severely limited.

In one embodiment, a high frequency converter is used to power at least one multi-pole motor. At least one single-stage or multi-stage compressor is driven by the motor. The multi-pole machine with added permanent magnets in the motor rotor achieves higher ratings and higher speeds and, therefore, has broader applications than prior art machines. The integrated system also has the benefits of improved reliability, improved efficiency, and ease of integration to the compressor for oil and gas applications. Furthermore, such features cannot be considered in isolation, since reduction in losses in the motor is often accomplished at the expense of increasing losses in the converter (and vice-versa).

### BRIEF DESCRIPTION OF THE DRAWINGS

FIG. 1 is a cross-sectional view of an integrated motor and compressor within a common pressure casing in accordance with the exemplary embodiments.

FIG. 2 is a schematic diagram of the integration of the various components of the electric-drive compressor system in accordance with the exemplary embodiments.

FIG. 3 shows a two level hybrid bridge power converter for use in the integrated electric drive compressor system shown in FIG. 1.

FIG. 4 shows a three level single-phase bridge power converter for use in the integrated electric drive compressor system shown in FIG. 1.

FIG. 5 shows another power converter topology for use in the integrated electric drive compressor system shown in FIG. 1.

FIGS. 6a and 6b show an electrical diagram of a converter topology with bypass capability.

FIG. 7 shows an embodiment of a power converter topology having bypass capability for use in the integrated electric drive compressor system shown in FIG. 1.

FIG. 8 shows an alternative embodiment of a power converter topology having bypass capability for use in the integrated electric drive compressor system shown in FIG. 1.

FIG. 9 shows an example of input pulse patterns used for the switches of the inverter stage of the H-bridge converter of FIG. 3.

### DETAILED DESCRIPTION

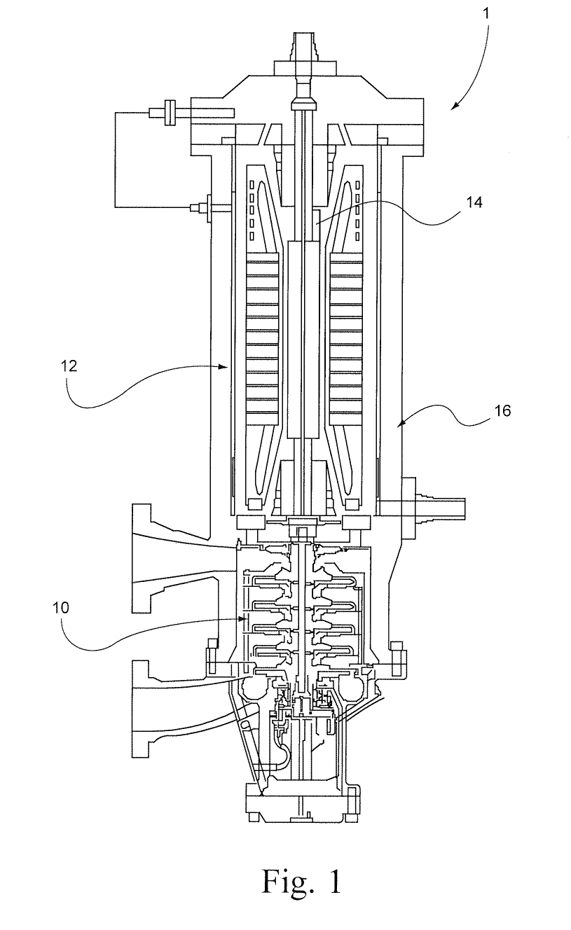

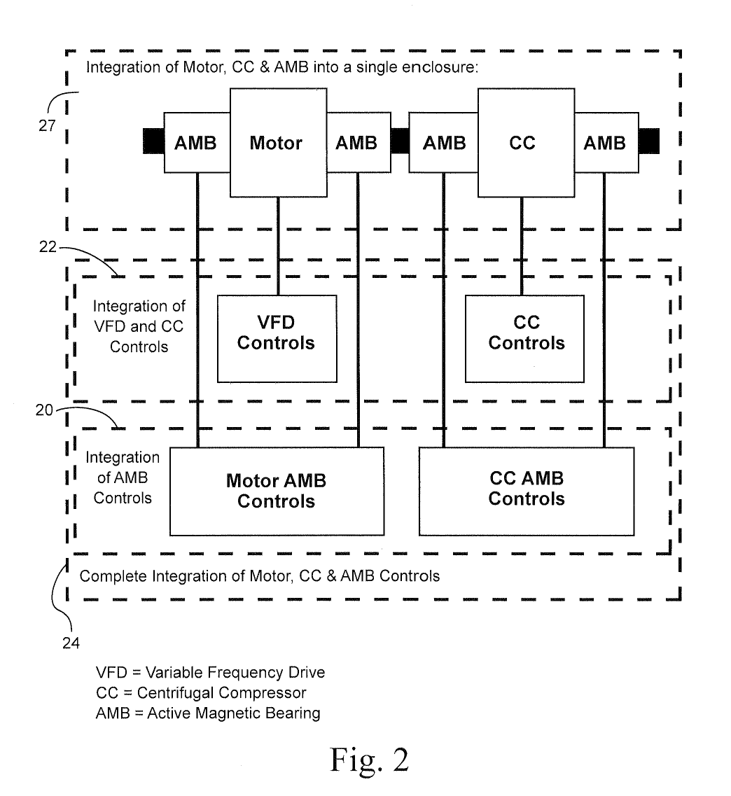

FIG. 1 shows in cross-section an exemplary embodiment of an integrated electric drive compressor system 1. A motor 12 with rotor 14 is electrically connected to a power converter unit 22 (see FIG. 2), which provides the motor with variable voltage and variable frequency. The frequencies may be in the range of 120 Hz to 700 Hz. The motor 12 is used to drive compressor 10. Both the motor (including its power converter) and the compressor are integrated into a common casing 16, to minimize pressure seals. The total number of penetrations in the casing is kept to a minimum to facilitate application of the system at high pressures.

The motor-compressor housing mechanically supports the stator core/winding assembly, bearing support brackets and stationary compressor pieces. It forms a pressure barrier between the exterior environment, e.g., sea water, and the internal coolants, e.g., process gas and oil. Two end plates provide access to both the top of the motor, and the bottom of the compressor section. The compressor is assembled as a cartridge in the single casing. The coupling of rotor components is obtained either via a Hirth serration or via a tie bolt through the motor and compressor shafts.

Permanent magnets are used to provide torque on the rotor shaft of the motor. During operation there is no contact between the rotor and the stator parts of the motor. The motor and compressor are supported by magnetic bearings rendering the system oil-free. Compared with conventional geared electric motor drives this technology provides the benefits of drastically reduced weight and footprint, reduced maintenance and improved reliability through the elimination of gas seals and the auxiliary oil system for bearings and gears. This allows for operation of the motor at high speeds, e.g., greater than 4,000 rpm, and with minimal losses.

Different levels of integration are made possible with the proposed configuration. The various components of the compressor system of FIG. 1, may be physically integrated in a single enclosure, and may have their control characteristics integrated as well, as shown in FIG. 2. Box 22 denotes the integration of the control unit for the variable frequency drive, i.e., the power converter connected to the motor, and the control unit for the centrifugal compressor. The controls for the active magnetic bearing for the motor and the compressor can also be integrated, as shown in Box 20. Boxes 24 and 27 depict the integration of the controls of all the components of the system, and the physical components of the system, respectively.

All control units are interconnected with a central control station. Remote monitoring capability allows for troubleshooting and facilitates the maintenance of the system. Furthermore, because of the design of the power converter, if there is a fault in one portion of the circuit, it is possible to isolate that portion, and continue the operation of the device.

The electrical characteristics of the motor and the power converter are chosen to minimize losses at the high frequencies required for high speed compression. New power electronics topologies are needed to maintain efficiency and to prevent overheating of key components.

Drive topologies for the high frequency power converter used in an exemplary embodiment of the integrated electric-drive compressor system include: a two-level hybrid bridge, a three level single-phase bridge, and dual voltage converters.

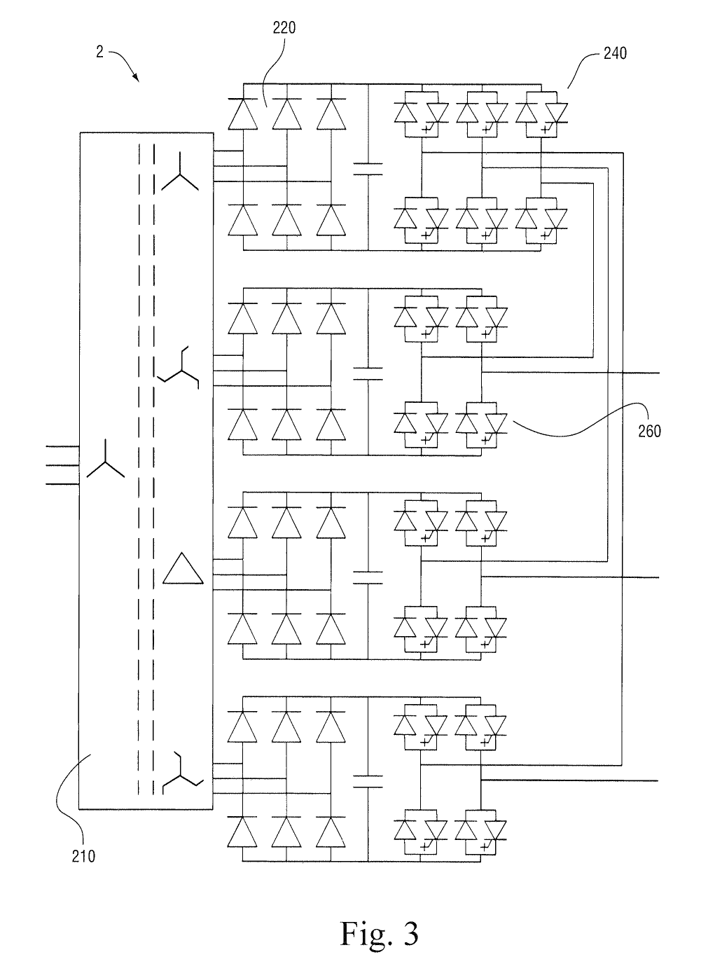

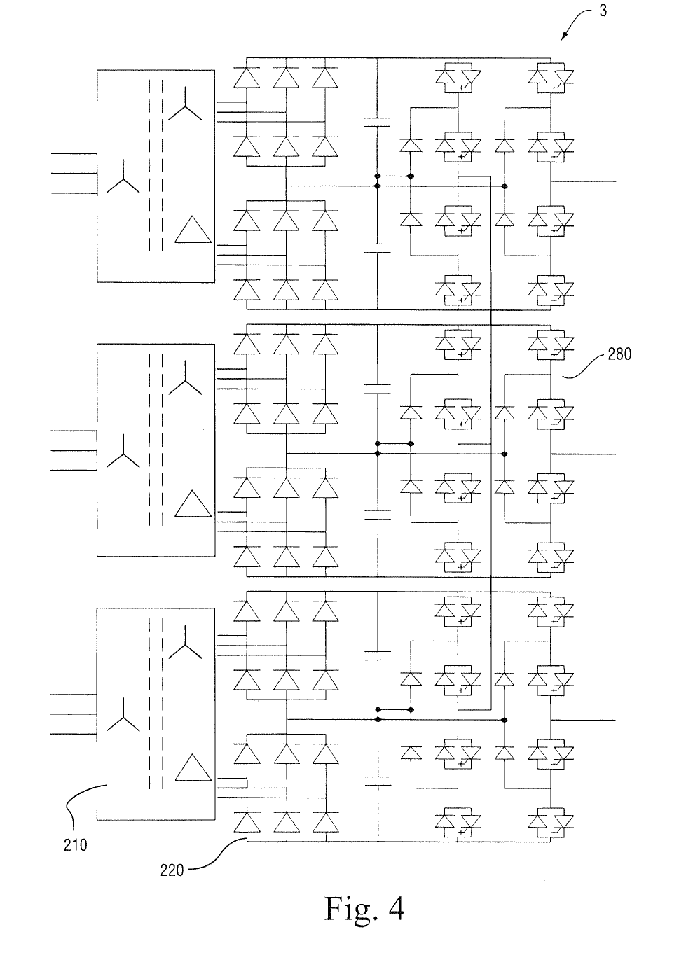

FIG. 3 and FIG. 4 show examples of two level and three level bridge power converter configurations, respectively, used to drive the high speed electric motor. At the input side of the two level hybrid bridge power converter 2 (shown in FIG. 3), the power converter is connected to a 50 Hz or 60 Hz power grid, usually at medium voltage level, e.g. 33 KV, through a three phase transformer 210. The three-phase variable voltage, variable frequency output is connected to the motor terminals. The power conversion is from fixed voltage and fixed frequency at the input to variable voltage, variable frequency at the output is done in two steps: first, rectification from ac to dc, followed by inversion from dc to ac. Diode rectifiers 220 are used for rectification, while fully controllable high power semiconductor switches, including Insulated Gate Bipolar Transistors (IGBTs), Integrated Gate Commutated Thyristors (IGCTs), and Metal-Oxide Semiconductor Field Effect Transistors (MOSFETs) are used for the inversion stage. The inversion stage includes a three-phase bridge 240 and three single phase bridges 260. The power converter controller receives torque/speed commands from the compressor controller. The motor currents and voltages are controlled in closed loop to ensure that the actual torque and speed of the motor dynamically track the set commands.

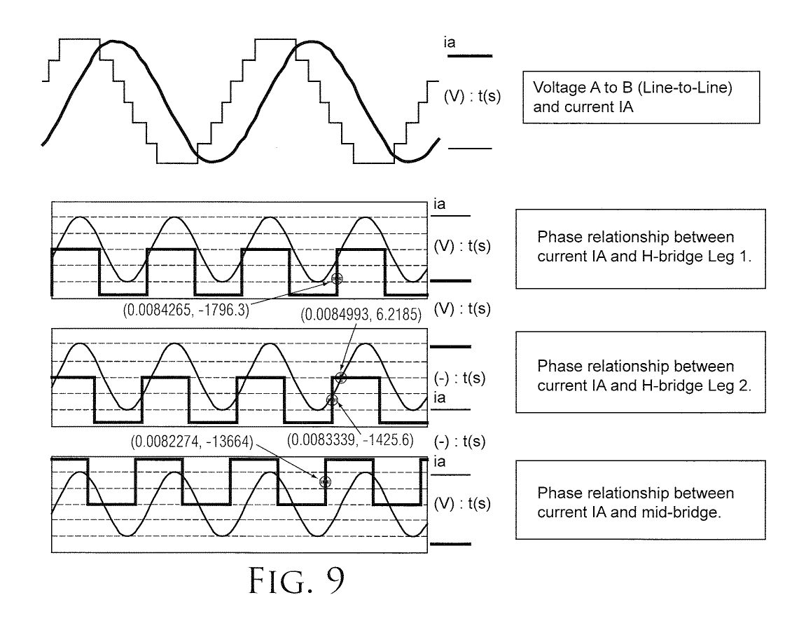

The operation of the switches in the inverter stage, including the switching frequency, determines the performance of the converter. An optimum pulse pattern yields minimum voltage harmonic distortion in the output voltage resulting in better operation of the motor. An example of an input pulse pattern used for the H-bridge topologies is shown in FIG. 9.

The three level bridge power converter 3 of FIG. 4 is similar to that of FIG. 3, with the exception that there are three single phase three level bridges 280 at the output providing the input voltages to the motor.

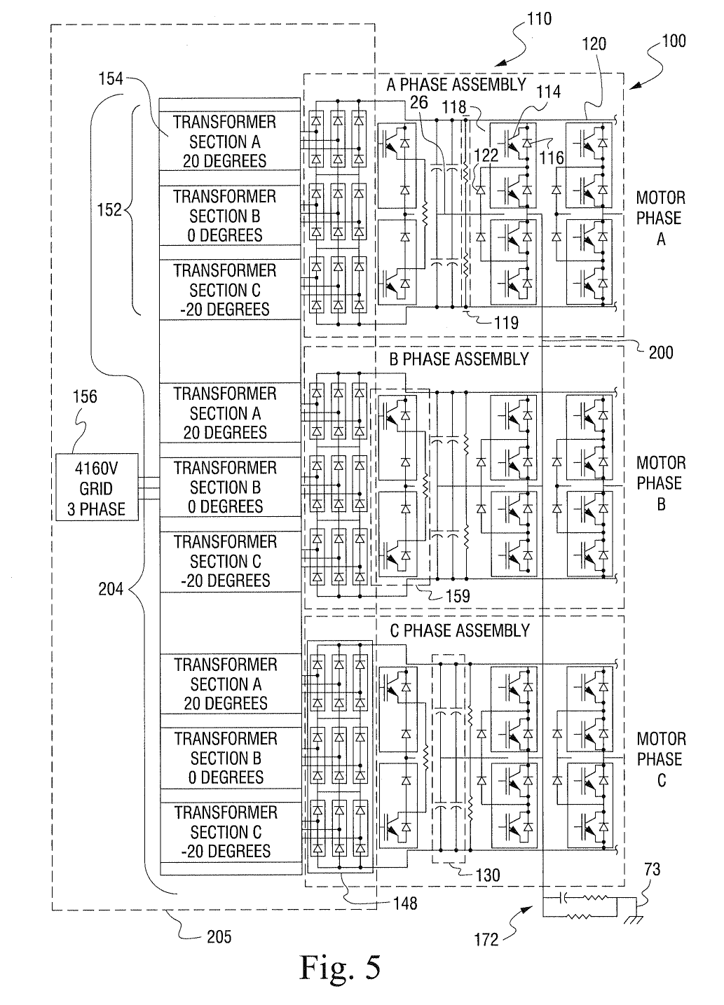

The power converter topology shown in FIG. 5 is also very similar to that of FIGS. 3 and 4. The primary difference lies in the input rectifier stage. Whereas, each dc link in FIG. 4 is fed by a 12-pulse rectifier (i.e., comprising two rectifiers), in FIG. 5, each dc link is fed by an 18-pulse rectifier (i.e., comprising three rectifiers). The converter includes a five level inverter circuit 110 with isolated DC busses 120, further including three identical neutral point clamped (NPC) phase bridge sections 100 connected in wye through a converter neutral connection 200 (not motor neutral) to generate the required output voltage. Each section is supplied by an isolated eighteen pulse rectifier 148 providing DC bus voltage to the phase bridge. Each DC bus voltage is filtered and split in half by a capacitor bank 130. The three DC busses should be isolated from each other and from ground. By such connection of the phase bridges, the peak voltage achievable between two converter output terminals is equal to 2 Vdc, rather than Vdc as in standard converter topologies.

Each bridge section 100 combines two NPC three level phase legs 118 with a common bus 120 (a positive rail and a negative rail) to provide an NPC H-bridge. The NPC three level phase legs include electrical switches 114 which are shown as IGBTs. The switches are paired with anti-parallel freewheeling diodes 116 to accommodate the inductive load currents, and clamping diodes 122. The resistor network 119 across the DC bus capacitor bank serves as a fixed safety bleed resistor and a balance network for initial capacitor charging.

The capacitor banks 130, shown in FIG. 5, are subjected to single phase loading conditions, unlike more conventional common DC bus converter topologies. There is a significant current at twice the fundamental output/load frequency resulting in significant DC bus voltage ripple al twice this frequency. Consequently, the converter requires more per unit (pu) DC bus capacitance to minimize this voltage ripple. Each of the three DC busses has ripple voltages phase-displaced according to the 120 degree load phase displacement.

The entire converter can be supplied by a single transformer 204 with three sets 152 of identical nine phase secondary windings. The transformer 204 receives power from an alternating current power grid 156. The transformer supplies the required isolation between each set of secondary windings and consequently the individual phase bridges. The eighteen pulse harmonic cancellation should occur within this multi-winding rectifier transformer 205. This embodiment is effective as long as continuity of current is achieved in the transformer secondaries. The transformer secondary impedance is used to force this condition. Current can become discontinuous at light loads, depending on transformer impedance and net DC bus capacitance levels. Optionally, every phase bridge section can contain a dynamic braking circuit 159. Three isolated dynamic braking resistors are used for this option.

Optionally, a grounding reference network 172 is coupled between the DC neutral point 26 and a ground frame 73. The ground reference network impedance is chosen to approximately match motor cable characteristic impedance. The network should be capable of continuous operation with a grounded motor phase. The voltage across the ground reference network is monitored by the controller for ground fault detection.

A Digital Signal processing (DSP)-based drive controller can achieve active neutral control by gate timing manipulation in order to maintain equal voltage balance on the split series capacitor banks (between the upper and lower halves; of the three DC links). It is desirable to also have tight control of the neutral charging currents in order to reduce the capacitance values required.

The controller of the converter system may include a digital signal processor including software, interface circuits for voltage and current feedback data acquisition, and digital timers for switch activations based on DSP computed timings.

The DSP includes vector control of both machine torque and flux. The DSP also includes modulation control for the hybrid NPC converter bridge. Additionally, the DSP includes active DC bus neutral voltage control by gate timing manipulation in order to maintain equal voltage balance on the split series capacitor banks.

The five level inverter circuit 110, shown in FIG. 5, is coupled to drive the electric motor, and the compressor linked thereto, shown in FIG. 1.

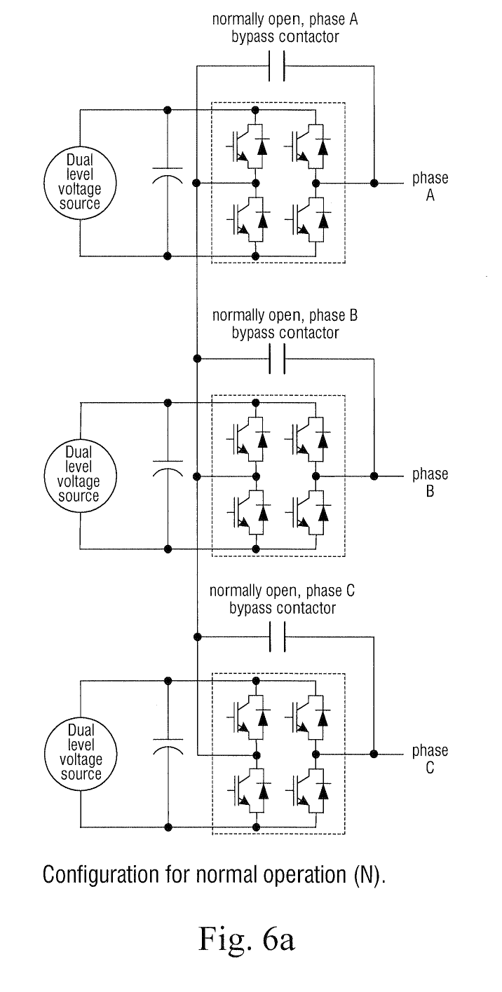

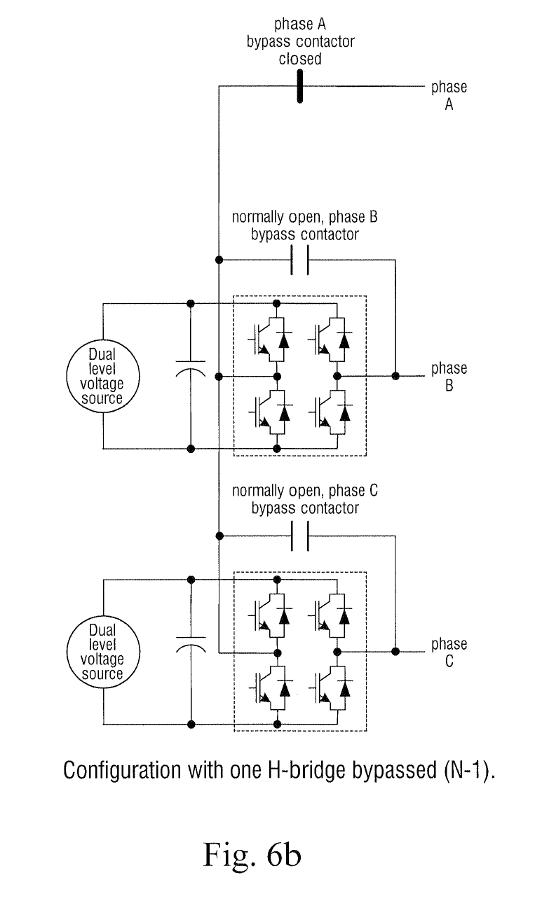

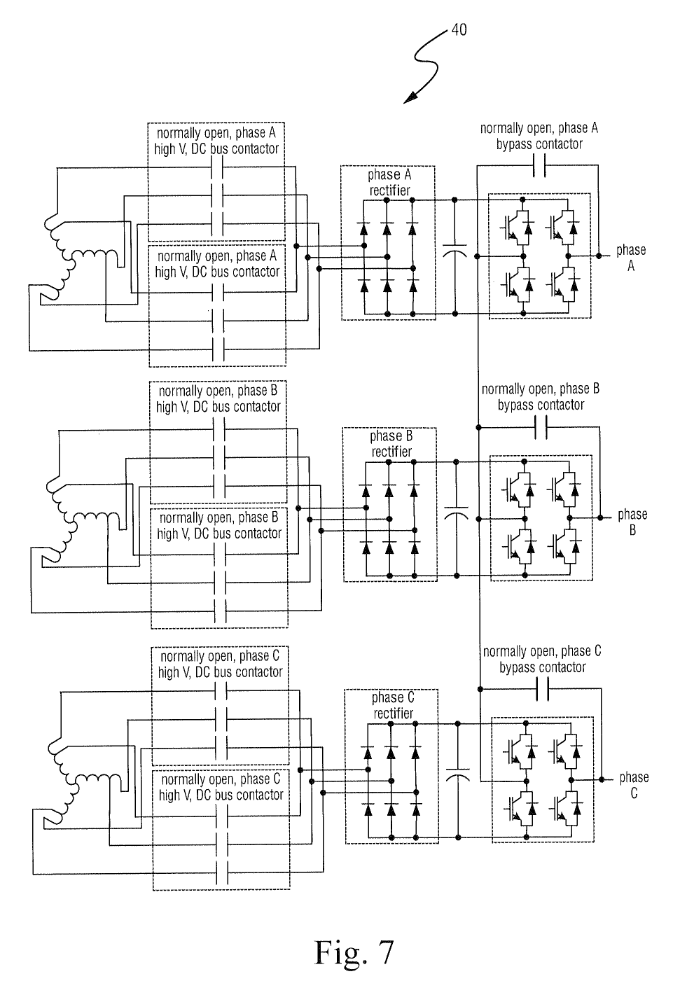

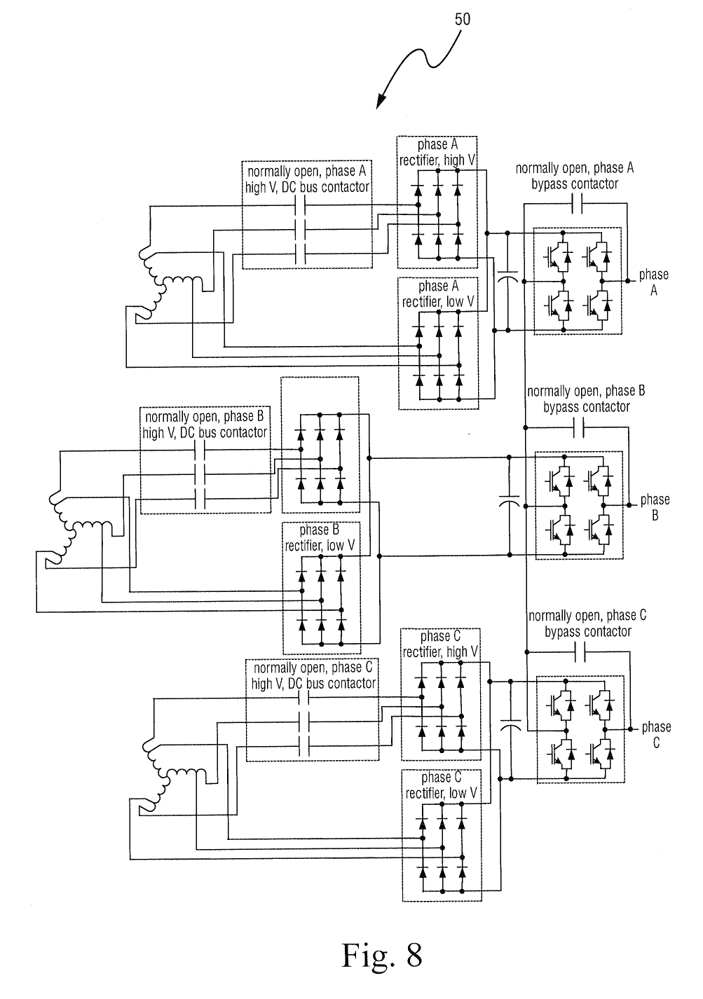

In another exemplary embodiment, a power converter topology utilizes two different levels of DC bus voltage to optimize the output power for two different modes of operation, normal operation (N) and operation with one failed bridge (N−1). The power sources for these bridges are rectified transformer windings. By making two transformer secondary voltage levels available, the bridge can be operated at two different DC bus voltage levels. In normal operation (N), the DC bus voltage is operated at the lower level, which reduces the switching loss in the power semiconductors, and also improves the reliability of all power devices that operate from this DC bus voltage. When the bridge has failed, it is bypassed (N−1), and the DC voltage is operated at the higher level. An electrical diagram of a method of using bypass contactors to easily switch between configuration N and N−1 is shown in FIGS. 6a. and 6b. Two different embodiments of this converter topology are shown in FIG. 7 and FIG. 8.

The configuration for normal operation (N) is shown in FIG. 6a, with all bypass contactors open. With a bypass contactor across each H-bridge, if any H-bridge fails, then it can be bypassed (N−1). In this way, it is possible to operate the load at a reduced power level, as shown in FIG. 6b. ISBT switches are shown in the circuit, but other power semiconductor switches, including IGCTs or MOSFETs may be used.

In an embodiment for a power converter 40 shown in FIG. 7 that incorporates the H-bridge of FIGS. 6a and 6b, two different contactors are used to select between two different voltage levels on the transformer secondary windings.

In another embodiment for a power converter 50 shown in FIG. 8 that incorporates the H-bridge of FIGS. 6a and 6b, a single contactor is closed to select the high voltage levels on the transformer secondary windings. When this contactor is open, a second rectifier circuit feeds the DC bus from the low voltage winding on the transformer secondary.

When the dual voltage power converter topology of FIG. 7 and FIG. 8 is combined with efficiently matching input pulse patterns, it results in further enhancement of output power capability, decrease in power loss in the IGCTs, while simultaneously reducing the Total Harmonic Distortion (THD) in the motor current.

Exemplary embodiments of the integrated electric-drive compressor system include one or more advantageous features over the prior art. For example, the system employs a direct drive which eliminates mechanical gears. A high frequency drive matches a wide range of operating speeds required in compressor applications. Multiple parallel converter modules can allow operation with one, two or more modules out of service. Advanced switching strategies such that the individual power modules either switch at fundamental frequencies or at small multiples of fundamental frequency can provide operating efficiencies.

In addition, remote configuration can optimize performance after specific modules have been removed from service. The outputs of the power modules can be interleaved appropriately to generate high quality multilevel voltage signals which results in very low torque ripple at high electrical frequencies without sacrificing efficiency. Use of a rotor with four or more poles can obtain desirable rotor dynamics and permit fabrication of windings with smaller coil spans.

The written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An integrated electric drive compressor system, said system comprising:
a high frequency power converter for powering at least one multi-pole motor;
at least one multi-pole motor powered by said high frequency power converter; and
at least one single-stage or multi-stage centrifugal compressor driven by said at least one multi-pole motor.

2. The system as claimed in claim 1, wherein said high frequency power converter includes a hybrid bridge, comprising two levels, for powering said at least one multi-pole motor.

3. The system as claimed in claim 1, wherein said high frequency power converter includes a bridge, comprising three levels, for powering said at least one multi-pole motor.

4. The system as claimed in claim 1, wherein said high frequency converter comprises a dual voltage converter having capability to operate in two different modes of operation.

5. The system as claimed in claim 1, wherein said high frequency converter, said motor and said compressor are integrated into a common enclosure.

6. The system as claimed in claim 1, further including integrated compressor and high frequency power converter controls and integrated active magnetic bearing controls.

7. The system as claimed in claim 1, wherein said high frequency power converter includes a control strategy to isolate the converter and to protect it from system faults.

8. The system as claimed in claim 1, wherein said high frequency power converter includes a remote monitoring capability to facilitate troubleshooting and maintenance, and performance.

9. The system as claimed in claim 1, wherein the at least one multi-pole motor has added permanent magnets to partially or completely eliminate active components.

10. The system as claimed in claim 1, wherein the at least one multi-pole motor operates at high speeds thereby eliminating the need for a gear box.

11. A method for powering an integrated electric drive compressor system, comprising:
powering at least one multi-pole motor with the output of a high frequency power converter; and
driving at least one single-stage or multi-stage centrifugal compressor with the output of said at least one multi-pole motor.

12. The method as claimed in claim 11, wherein said high frequency power converter includes a hybrid bridge, comprising two levels, for powering said at least one multi-pole motor.

13. The method as claimed in claim 11, wherein said high frequency power converter includes a bridge, comprising three levels, for powering said at least one multi-pole motor.

14. The method as claimed in claim 11, wherein said high frequency converter comprises a dual voltage converter having capability to operate in two different modes of operation.

15. The method as claimed in claim 11, further comprising integrating said high frequency converter, said motor and said compressor into a common enclosure.

16. The method as claimed in claim 11, further including integrating the controls of said compressor and high frequency power converter and integrating the controls of active magnetic bearings.

17. The method as claimed in claim 11, wherein said high frequency power converter includes a control strategy to isolate the converter and to protect it from system faults.

18. The method as claimed in claim 11, wherein said high frequency power converter includes a remote monitoring capability to facilitate troubleshooting and maintenance, and performance.

19. The method as claimed in claim 11, further comprising adding to the at least one multi-pole motor permanent magnets to partially or completely eliminate active components.

20. The method as claimed in claim 11, wherein the at least one multi-pole motor operates at high speeds thereby eliminating the need for a gear box.
